(19) United States
(12) Patent Application Publication
(10) Pub. No.: US 2014/0376423 A1
(43) Pub. Date: Dec. 25, 2014

(54) COEXISTING WIRELESS SYSTEMS

(71) Applicant: VODAFONE IP LICENSING LIMITED, Newbury, Berkshire (GB)

(72) Inventors: Zhanhong Lu, Newbury (GB); Ralf Irmer, Newbury (GB)

(21) Appl. No.: 14/357,754

(22) PCT Filed: Nov. 8, 2012
(86) PCT No.: PCT/GB2012/052773

§ 371 Date: May 12, 2014

(30) Foreign Application Priority Data
Nov. 11, 2011 (GB) 1119510.4

(51) Int. Cl. H04W 72/08; H04L 5/14

(52) U.S. Cl. CPC H04W 72/082; H04L 5/14
USPC 370/280; 370/329

(57) ABSTRACT

The present invention provides a method of cancelling interference caused by a transmitter of a first wireless system to a receiver of a second wireless system, the transmitter and receiver being operative in adjacent frequency bands. The method comprises receiving a signal at the second wireless system that is corrupted by interference caused by a wireless transmission from the first wireless system; providing the second wireless system with transmitted symbols of the wireless transmission from the first wireless system; and processing the signal received at the second wireless system using the transmitted symbols of the wireless transmission in order to cancel the interference.

### TECHNICAL FIELD OF THE INVENTION

The present invention concerns a method of cancelling interference caused by a transmitter of a first wireless system to a receiver of a second wireless system. The transmitter and receiver are operative in adjacent frequency bands. It also concerns a cooperative wireless system comprising these first and second wireless systems.

### BACKGROUND TO THE INVENTION

Wireless systems are increasingly ubiquitous. This causes problems for operators of wireless networks. Administrators of wireless spectrum ensure that different wireless systems do not use the same frequency band in such a way that they cause interference to one another. Nevertheless, it is desirable for different wireless systems to use adjacent frequency bands, for efficient allocation of wireless resources. Where these wireless systems are proximate to one another, especially where the wireless systems operate from a fixed location, adjacent channel interference can still result.

This is a particular problem for cellular wireless networks (although it also applies to other kinds of wireless network). As an example, some such wireless systems use time division duplex (TDD) in unpaired bands. Others use frequency division duplex (FDD) in paired bands. The uplink (or downlink) band allocated to an FDD system can be adjacent to the band allocated to a TDD system. The FDD and TDD systems can be deployed at the same site especially where the systems are base stations of the respective networks. Alternatively, the FDD and TDD systems could be deployed on neighbouring, proximate sites, for instance where the two systems use respective antenna masts on one building. The systems can be operated by the same network operator or different network operators. Each wireless system could be used to communicate with user terminals (referred to as “access”) or to communicate with other wireless network infrastructure elements (known as “backhaul”).

Adjacent channel interference limits the performance of the receiver in one or both of the systems. For example, the data rate, error rate and reliability can all be affected.

There are a number of existing solutions. It is known to place guard frequency bands between the adjacent bands allocated to the two systems. In other words, the uplink for downlink) band allocated to the FDD system is not directly adjacent the band allocated to the TDD system. These guard bands can have a size of 5 MHz, 10 MHz or even more. The problem of adjacent channel interference is thereby mitigated. However, this wastes the precious resource of spectrum bandwidth, reducing the available system capacity and the data rate that might otherwise be achieved.

The second known approach is to add additional filtering to the transmitter of the interference-generator, the receiver of the interference or both. This approach is costly, limits flexibility and increases size, complexity and power consumption of both wireless systems.

The third current approach is termed intelligent deployment. The parameters of the first wireless system, second wireless system or both can be to reduce interference. For example, the location, direction and profile of the respective antennas for the FDD and TDD systems can be set to mitigate interference. This requires a high level of coordination between the operator of the FDD and TDD systems and further limits flexibility. Also, any measures taken according to this approach must fit within the physical constraints available. This limits its practicality.

### SUMMARY OF THE INVENTION

Against this background, the present invention provides a method of cancelling interference caused by a transmitter of a first wireless system to a receiver of a second wireless system, in which the transmitter and receiver are operative in adjacent frequency bands. The method comprises: receiving a signal at the second wireless system that is corrupted by interference caused by a wireless transmission from the first wireless system; providing the second wireless system with transmitted symbols of the wireless transmission from the first wireless system; and processing the signal received at the second wireless system using the transmitted symbols of the wireless transmission in order to cancel the interference.

Interference cancellation is known, for example in Multiuser Detection (MUD) technologies. Normally, the interference signal is not known a priori. In most cases, the interference signal is estimated. However, the present, invention provides the second wireless system with the symbols transmitted by the first wireless system. This is advantageously possible, especially (but not necessarily) when the first and second wireless systems are co-located or proximately located. Using this approach, the performance of the second wireless system can be significantly improved, without a significant increase in cost or complexity and without the need to fit within limited physical constraints. Moreover, interference cancellation can provide high performance. The data rate, error rates and reliability of both wireless systems can be significantly improved.

In the preferred embodiment, either the first or second wireless system is a frequency division duplex (FDD) system. The other wireless system is a time division duplex (TDD) system.

Alternatively, both the first and second wireless systems are TDD systems. Operating in the adjacent bands, interference may be caused either by the lack of synchronization, between the two TDD systems or/and differences in downlink/uplink ratio configuration between the two IUD systems.

In many cases, the first wireless system, second wireless system or both are fixed in location. In the preferred embodiment, the first wireless system, second wireless system or both are base stations of one or more cellular networks. Alternatively, the first wireless system, second wireless system or both may be user equipment (UE) of one or more cellular networks. Where the first wireless system, second wireless system or both are part of a cellular network, this may be GSM, UMTS, HSPA or LTE. In a further alternative, the first wireless system, second wireless system or both may be parts of other kinds of wireless network, such as WiFi, WiMax or another wireless network.

Beneficially, the step of processing the received signal to cancel the interference may comprise one or more of: successive interference cancellation; and linear interference cancellation.

In some embodiments, the step of processing the received signal to cancel the interference comprises: recreating the interference received at the second wireless system using the transmitted symbols of the wireless transmission; and subtracting the recreated interference from the received signal. Where the interference is additive (i.e. a linear interference model), the recreated interference can simply be subtracted in order to cancel its effects.

Alternatively, the method further comprise: determining one or more parameters of an interference model between the transmitter of the first wireless system and the receiver of the second wireless system. Then, the step of processing the signal received at the second wireless system may use the one or more parameters of the interference model in order to cancel the interference. This approach can be applied when non-linear effects are causing the interference. Optionally, one or more parameters of the interference model may comprise at least one of: the modulation scheme used for the wireless transmission; and non-linearities of the transmitter.

Advantageously, the method may further comprise: estimating one or more parameters of the channel between the transmitter of the first wireless system and the receiver of the second wireless system. Then, the step of processing the signal received at the second wireless system may use the one or more estimated parameters of the channel. Channel estimation is a known technology. Using the one or more estimated parameters of the channel together with the symbols, transmitted by the first wireless system can provide an estimate of the interference received at the second wireless system. This further improves interference cancellation. Optionally, the one or more channel parameters may comprise at least one of: the channel impulse response; and the noise level.

In one embodiment, the method further comprises: communicating information about the signal received at the second wireless system to the first wireless system. Then, the step of estimating one or more parameters of the channel may be carried out at the first wireless system. The information about the signal received at the second wireless system may be the RF signal received by the second wireless system or the baseband signal derived from that RF signal. Advantageously, the first wireless system may be able to carry out channel estimation in easier way than the second wireless system, since it transmitted the original in signal. Alternatively, the second wireless system can carry out channel estimation. Beneficially, channel estimation is carried out using the baseband signal derived from the RF signal received at the second wireless system.

In some embodiments, the step of estimating one or more parameters of the channel or determining one or more parameters of an interference model may comprise: receiving reference symbols transmitted by the transmitter of the first wireless network at the receiver of the second wireless network, information about the reference symbols being known to the second wireless system; and evaluating the received reference symbols based on the information about the reference symbols, in order to determine the one or more parameters of the channel or the one or more parameters of the interference model. The reference symbols may be those set by the standards of the wireless network used by the first wireless system (this may include pilot symbols). Alternatively, the reference symbols may be specific test, signals transmitted by the first wireless system for this purpose. In a further alternative, data symbols can be used to estimate the channel, or interference parameters by applying conventional blind or semi-blind parameter estimation techniques.

In embodiments, the transmitter of the first wireless system is coupled to a plurality of antennas. Then, the step of estimating one or more parameters of the channel or determining one or more parameters of an interference model may be carried out for each of the plurality of transmitter antennas. In this way, the gain possible from transmitter antenna diversity in MIMO approaches can be applied to interference cancellation as well

Optionally, the receiver of the second wireless system is coupled to a plurality of antennas. The received signal can then be formed by a combination of the signals received from each of the plurality of antennas. The gain possible through receiver antenna diversity can also therefore be made available for interference cancellation. In this respect, the step of estimating one or more parameters of the channel or determining one or more parameters of an interference model is preferably carried out for each of the plurality of receiver antennas.

In other embodiments, the method may further comprise: communicating from the second wireless system to the first wireless system, information about the interference; and making a further wireless transmission from the first wireless system, at least one parameter of the further wireless transmission being set on the basis of the communicated information about the interference. In this way, a feedback loop may be created between the first wireless system and second wireless system.

Preferably, the information about the interference communicated from the second wireless system to the first wireless system comprises estimated interference information. The further wireless transmission (i.e transmit signals) from the first wireless system is then modified for subsequent symbols in order to mitigate or substantially reduce the interference on the second system. This modification of the transmit signal may be accomplished by using iterative interference cancellation techniques, intelligent scheduling of resource blocks, selection of transmit codes, change of modulation format or transmit power for certain scheduling resources or predistortion of the symbols for the further wireless transmission, or by a combination of the above. This approach can be referred to as interference avoidance, or predistortion, or intelligent scheduling.

In the case where the first wireless system is causing interference to several elements of the second wireless system, such as multiple base stations or multiple terminals, a relevant weighting of the different elements has to be made in order to determine the signal to be transmitted from the first wireless system.

An element of the second wireless system may similarly be disturbed by multiple elements of the first wireless system, i.e. different sectors, antennas, base stations or terminals. The skilled person will appreciate that in such cases all interference sources may be considered in the same interference cancellation step provided appropriate information concerning each of the interference sources is provided by the first wireless system.

Preferably, the step of providing the second wireless system with transmitted symbols comprises communicating the transmitted symbols from the first wireless system to the second wireless system through a communications interface that is separate from the receiver of the second wireless system. More preferably, the separate communications interface may be more reliable than the communications interface used by the receiver of the second wireless system. For example, a non-wireless communications interface may be used, such as a cable. Beneficially, the separate communications interface may be a dedicated interface for communicating the transmitted symbols, which is typically direct. Alternatively, the separate communications interface may be part of a network linking the first and second wireless systems.

In a further aspect, the present invention provides a computer program, configured to effect the method as described herein when operating on a processor.

The present invention, can alternatively be embodied as a controller arranged: to control a transmitter of a first wireless system to make a wireless transmission; to control a receiver of a second wireless system to receive a signal that is corrupted by interference caused by the wireless transmission from the first wireless system; to provide the second wireless system with transmitted symbols of the wireless transmission from the first wireless system; and to control the second wireless system to process the received signal using the transmitted symbols of the wireless transmission in order to cancel the interference. In such cases, the transmitter of the first wireless system and the receiver of the second wireless system are preferably configured to operate in adjacent frequency bands.

In a yet further aspect, a cooperative wireless system is provided, comprising: a first wireless system, comprising a transmitter configured to make a wireless transmission; a second wireless system, comprising a receiver, arranged to receive a signal that is corrupted by interference caused by a wireless transmission from the first wireless system, the transmitter and receiver being configured to operate in adjacent frequency bands; and a system in arranged to provide the second wireless system with transmitted symbols of the wireless transmission from the first wireless system. Then, the second wireless system may be configured to process the received signal using the transmitted symbols of the wireless transmission in order to cancel the interference.

It will be understood that the controller and cooperative wireless system can optionally comprise features used to implement any of the method features described above. Also, any combination of the individual method features or apparatus features described may be implemented, even though not explicitly disclosed.

### BRIEF DESCRIPTION OF THE DRAWINGS

The invention may be put into practice in various ways, one of which will now be described by way of example only and with reference to the accompanying drawings in which:

FIG. 1 shows a schematic diagram of coexisting wireless systems in accordance with an embodiment of the present invention; and

FIG. 2 shows a schematic illustration of functional blocks used to implement the coexisting wireless systems of FIG. 1.

### DETAILED DESCRIPTION OF PREFERRED EMBODIMENTS

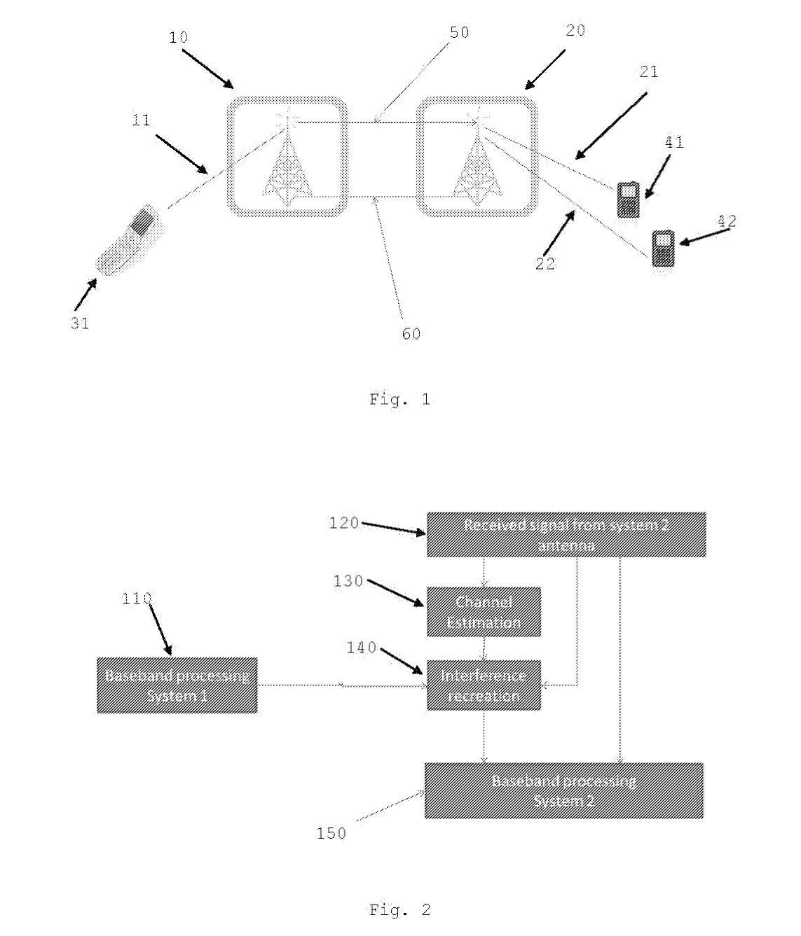

Referring first to FIG. 1, there is shown a schematic diagram of coexisting wireless systems, including a first wireless system 10 and a second wireless system 20. The first wireless system 10 is in communication with a first user equipment (UE) 31 over a first communication channel 11 on a first frequency band. The second wireless system 20 is in communication with a second UE 41 and a third UE 42 over second communication channel 21 and third communication channel 22 respectively. The second communication channel 21 and the third communication channel 22 use a second frequency band, adjacent to the first frequency band. By adjacent, it may be understood that the first and second frequency bands are not substantially overlapping or essentially distinct in their respective ranges, indeed there may be a limited number of other frequency bands between the first and second frequency bands. Throughout this document “adjacent” bands may be considered to refer to bands sufficiently close in frequency that significant interference is created in one band as a result of signals carried in another band—so-called out-of-band. interference. Adjacent frequency bands can also refer to two frequency ranges, each having a respective lower limit and upper limit, the upper limit of the first, frequency range being substantially the same as the lower limit of the second frequency range. Alternatively, there can be a gap between the upper limit of the first frequency range and the lower limit of the second frequency range. Typically the gap is smaller than the width of either the first frequency range or the second frequency range.

The signals transmitted by the first wireless system 10 are propagated through an interference channel 50 and are perceived as interference by the second wireless system 20.

For example, where a first wireless system 10 uses TDD, such that both uplink and downlink transmissions between the first wireless system 10 and the first UE 31 take place over the same communications channel 11, the second wireless system 20 may use FDD, such that only transmissions from the second UE 41 and third UE 42 take place over the second communication channel 21 and third communication channel 22 respectively. Then, the interference channel 50 relates to transmissions from the first wireless system 10 that are received by the second wireless system 20 and cause interference to signals received from the second UP 41 and second UE 42 at the second wireless system 20.

A further communications link 60 is provided between the first wireless system 10 and second wireless system 20. The wireless systems may be connected using either baseband or RF signals. This may be provided using a dedicated link, such as a cable, or using another backhaul communication interface.

The second wireless system 20 may then use interference cancellation techniques to suppress the interference received, over interference channel 50. These can include successive interference cancellation or linear interference cancellation, such as a Wiener filter, Kalman filter or Zero Forcing Filter. These mechanisms were developed for cancellation of interference in the same frequency band. However, it is advantageously recognised that they may be utilised for interference caused in adjacent frequency bands.

Referring now to FIG. 2, there is shown a schematic illustration of the functional blocks for effecting interference cancellation. The baseband processing system 110 of the first wireless system 10 provides to the second wireless system 20, the signal that is being transmitted by the first wireless system 10. This signal comprises transmitted symbols. At the same time, the second wireless system 20 receives those transmitted symbols as interference at receiver 120.

The wireless interference channel 50 between the first wireless system 10 and second wireless system 20 can be estimated or modelled. This interference channel 50 may contain distortions of filters, multipath interference and other propagation effects and may include spillage of the transmitted signal no the frequency band used by the second wireless system 20.

Channel estimation block 130 can estimate the channel by evaluating the reference symbols transmitted by the first wireless system 10. In particular, reference symbols are embedded in GSM, UNITS, HSPA or LTE signals. Channel estimation block 130 is part of the second wireless system. 20.

Interference recreation block 140 combines the information about the transmitted signal received from the baseband processing block 110 of the first wireless system with the channel estimation provided by tan channel estimation block 130. The recreating interference can be subtracted from the overall signal received at the receiver 120 of the second wireless system 20. The interference caused by the first wireless system 10 to the second wireless system 20 can therefore be reduced or mitigated.

Although an embodiment of the invention has now been described above, the skilled person will recognise that various modifications or adjustments can be made. For example, the channel estimation can be carried out by the first wireless system 10. This can be achieved by communicating the complete RF signal received by the second wireless system 20 back to the first wireless system 10. Alternatively, the baseband signal can be used. The first wireless system 10 can carry out channel estimation in an easier way, since it transmitted the signal containing the reference symbols in the first place. The channel estimation values (channel impulse response, noise level and interference) may be provided to the second wireless system 20, in order to recreate the interference in the interference recreation block 140. Alternatively, the interference recreation block 140 can also sit within the first wireless system 10. Then the recreated interference can be communicated back to the second wireless system 20.

Where the interference is additive, i.e. linear in nature, subtraction of the recreated interference should result in effective cancellation. However, where non-linear effects cause the interference, an interference model may be desirable. Calibration and parameterisation of this model is advantageous. This can be achieved using reference signals (such as those used for channel estimation.) or the complete RF signal transmitted by the first wireless system 10. The interference model can, for instance, contain interference caused by the modulation process and non-linearities in the transmitter. The interference is referred to in some cases as Out Of Band Emission (OOBE), Receiver Blocking or both. If Receiver Blocking plays a major role, the interference model may consider the whole chain consisting of transmitter, wireless channel and receiver in a combined model, where the model parameters can be estimated, i.e. leveraging reference signals (such as pilot symbols) or known data signals.

The invention can also be extended to the operation of multiple antenna elements (MIMO). Cancellation in these cases can either be accomplished on individual antenna elements, or on the combined signal. The corresponding channel model can be adapted for such cases.

A further embodiment of the invention creates a feedback loop between the first wireless system 10 and second wireless system 20. For example, by communicating information about the interference received at the second wireless system 20, iterative interference cancellation can be applied. Additionally or alternatively, methods known for power amplifier linearization, such as predistortion, may be applied to the transmitted symbols of the first wireless system 10. This can be used in addition to interference cancellation in the second wireless system 20.

In the case that reference signals are not sufficient to calibrate the interference model, special calibration signals can be sent from the first wireless system 10.

1. A method of cancelling interference caused, by a transmitter of a first wireless system to a receiver of a second wireless system, the transmitter and receiver being operative in adjacent frequency bands, the method comprising:
receiving a signal at the second wireless system that is corrupted by interference caused by a wireless
transmission from the first wireless system;
providing the second wireless system with transmitted symbols of the wireless transmission from the first wireless system; and
processing the signal received at the second wireless system using the transmitted symbols of the wireless transmission in order to cancel the interference.

2. The method of claim 1, wherein either the first wireless system or the second wireless system is a Frequency Division Duplex, FDD, system and wherein the other wireless system is a. Time Division Duplex, TDD, system.

3. The method of claim 1, wherein the first and second wireless systems are base stations of one or more cellular networks.

4. The method of claim 1, wherein the step of processing the received signal to cancel the interference comprises:
recreating the interference received at the second wireless system using the transmitted symbols of the wireless transmission; and
subtracting the recreated interference from the received signal.

5. The method of claim 1, further comprising:
determining one or more parameters of an interference model between the transmitter of the first wireless system and the receiver of the second wireless system; and
wherein the step of processing the signal received at the second wireless system uses the one or more parameters of the interference model in order to cancel the interference.

6. The method of claim 1, further comprising:
estimating one or more parameters of the channel between the transmitter of the first wireless system and the receiver of the second wireless system; and
wherein the step of processing the signal received at the second wireless system uses the one or more estimated parameters of the channel.

7. The method of claim 6, further comprising:
communicating information about the signal received at the second wireless system to the first wireless system; and
wherein the step of estimating one or more parameters of the channel is carried out at the first wireless system.

8. The method of claim 5, wherein the step of estimating one or more parameters of the channel or determining one or more parameters of an interference model comprises:
receiving reference symbols transmitted by the transmitter of the first wireless network at the receiver of the second wireless network, information about the reference symbols being known to the second wireless system; and
evaluating the received reference symbols based on the information about the reference symbols, in order to determine the one or more parameters of the channel or one or more parameters of the interference model.

9. The method of claim 5, wherein the transmitter of the first wireless system is coupled to a plurality of antennas, and wherein the step of estimating one or more parameters of the channel or determining one or more parameters of an interference model is carried out for each of the plurality of transmitter antennas.

10. The method of claim 1, wherein the receiver of the second wireless system is coupled to a plurality of antennas, the received signal being formed by a combination of the signals received from each of the plurality of antennas.

11. The method of claim 10, wherein the step of estimating one or more parameters of the channel or determining one or more parameters of an interference model is carried out for each of the plurality of receiver antennas.

12. The method of claim 1, further comprising:
communicating from the second wireless system to the first wireless system, information about the interference; and
making a further wireless transmission from the first wireless system, at least one parameter of the further wireless transmission being set on the basis of the communicated information about the interference.

13. The method of claim 1, wherein the step of providing the second wireless system with transmitted symbols comprises communicating the transmitted symbols from, the first wireless system to the second wireless system through a communications interface that is separate from the receiver of the second wireless system.

14. A non-transitory computer readable medium having stored thereon computer readable instructions that, when executed by a processor, cause a computing system to perform the method of claim 1.

15. A cooperative wireless system, comprising:
a first wireless system, comprising a transmitter configured to make a wireless transmission;
a second wireless system, comprising a receiver, arranged to receive a signal that is corrupted by interference caused by a wireless transmission from the first wireless system, the transmitter and receiver being configured to operate in adjacent frequency bands; and
a system interface, arranged to provide the second wireless system with transmitted symbols of the wireless transmission from the first wireless system; and
wherein the second wireless system is configured to process the received signal using the transmitted symbols of the wireless transmission in order to cancel the interference.
